(19) United States
(12) Patent Application Publication
(10) Pub. No.: US 2025/0154043 A1
(43) Pub. Date: May 15, 2025

(54) METHODS AND APPARATUS FOR MANUFACTURING A RIBBON

(71) Applicant: CORNING INCORPORATED, CORNING, NY (US)

(72) Inventors: WILLIAM JASON HILL, LINDLEY, NY (US); JACOB IMMERMAN, CORNING, NY (US); ANIELLO MARIO PALUMBO, PAINTED POST, NY (US); HAMIDREZA PIRAYESH, SAN DIEGO, CA (US); ROHIT RAI, PAINTED POST, NY (US); JOHN ROBERT SALTZER, Jr., BEAVER DAMS, NY (US)

(21) Appl. No.: 18/838,047

(22) PCT Filed: Feb. 27, 2023
(86) PCT No.: PCT/US2023/013919

§ 371 Date: Aug. 13, 2024

Related U.S. Application Data
(60) Provisional application No. 63/314,593, filed on Feb. 28, 2022.

(51) Int. Cl. C03B 13/16; C03B 13/08

(52) U.S. Cl. CPC C03B 13/16; C03B 13/08

(57) ABSTRACT

Methods of manufacturing a ribbon include contacting the ribbon with a recess of a forming roll to impart a protrusion to a first major surface of the ribbon. Methods include receiving the ribbon on a support surface positioned downstream from the forming roll. A second major surface of the ribbon is opposite the first major surface and faces the support surface. The protrusion extends in a direction away from the support surface. Methods include forming a vacuum between the second major surface of the ribbon and the support surface to bias the ribbon toward the support surface.

### CROSS-REFERENCE TO RELATED APPLICATION

This application claims the benefit of priority under 35 U.S.C. § 119 of U.S. Provisional Application Ser. No. 63/314,593 filed on Feb. 28, 2022, the content of which is relied upon and incorporated herein by reference in its entirety.

### FIELD

The present disclosure relates generally to methods for manufacturing a ribbon and, more particularly, to methods for manufacturing a ribbon with a glass manufacturing apparatus comprising a support surface.

### BACKGROUND

It is known to manufacture molten material into a ribbon of nominally uniform thickness with a glass manufacturing apparatus. A pair of forming rolls can be spaced apart to define a gap that can receive the molten material. The molten material can pass through the gap, whereupon the molten material can be formed into a ribbon of nominally uniform thickness. Sheets from such ribbon can then be cut into smaller parts and finished into a glass article of non-uniform thickness distribution by grinding, machining, and/or polishing the ribbon. However, the grinding, machining, and/or polishing process is inefficient and costly when the formed sheets have uniform thickness whereas finished glass article has significant thickness variation. It is possible to reduce finishing costs and improve material utilization by forming glass sheets of non-uniform thickness by passing the molten glass through shaped rolls, e.g. rolls with grooves or pockets. However, adding grooves or pockets or other such features on the forming rolls, to create sheets of desired thickness variation, can create several challenges. For example, temperature difference between the thick and thin portions of the glass ribbon may be significant and may lead to high stresses and warp. Mitigating the defects in the variable thickness sheet in the rolling process can be challenging, requiring significant increase in equipment complexity, cost, and footprint

### SUMMARY

The following presents a simplified summary of the disclosure to provide a basic understanding of some aspects described in the detailed description.

There are set forth methods of manufacturing a ribbon, comprising introducing a stream of molten glass along a travel path in a travel direction to a gap defined between a first forming roll and a second forming roll, and passing the stream of molten glass through the gap to form a ribbon. A protrusion can be formed in the ribbon by contacting the stream of molten glass with a recess of the first forming roll. As a result of the forming process, defects may be present in the ribbon, for example, stress that is outside of a desirable range and warp that causes the ribbon to not be planar. To address these issues, the ribbon can be treated downstream from the forming rolls. For example, in some aspects, the ribbon can be planarized by being positioned on a support surface within a furnace. To maintain a desired average stress in the ribbon, the furnace is heated and cooled to a desired temperature for a predetermined period of time. In aspects, this planarization can occur in a separate downstream process, for example, by re-processing the cut, as-formed ribbon from a rolling process. Alternately, in aspects, this planarization can be integrated with the rolling process (e.g., as a fully online or one-step process).

Alternatively, the ribbon can be positioned on a support surface comprising a plurality of openings. Air can be drawn through the openings to form a vacuum between the ribbon and the support surface. The vacuum and the support surface can planarize the ribbon. The support surface and the ribbon can be placed within the furnace, such that the furnace is heated and cooled to a desired temperature for a predetermined period of time. The furnace can comprise a batch furnace that may be heated or cooled as desired, or a lehr with temperatures of each zone fixed at different levels to heat and/or cool the ribbon per a desired thermal profile.

In another alternative, the ribbon can be planarized by positioning the ribbon on a support surface and contacting the ribbon with a mold. The mold can apply a pressure to the protrusion of the ribbon, which can bias the ribbon toward the support surface. The ribbon, the support surface, and the mold can be placed within the furnace, such that the furnace is heated and cooled to a desired temperature for a predetermined period of time. As a result of any of these processes, the ribbon can comprise a flatness that is less than about 100 μm and an average stress that is less than about 7 MPa.

Aspect 1. Methods of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
forming a vacuum between a second major surface of the ribbon and the support surface to bias the ribbon toward the support surface

Aspect 2. Methods of aspect 1, wherein the ribbon comprises a viscosity within a range from about 10⁶ poise to about 10¹⁰ poise

Aspect 3. Methods of aspects 1-2, wherein the support surface comprises a plurality of openings.

Aspect 4. Methods of aspect 3, wherein a first opening of the plurality of openings comprises a diameter within a range from about 0.1 mm to about 3 mm.

Aspect 5. Methods of aspect 4, wherein a second opening of the plurality of openings is spaced a distance apart from the first opening, the distance within a range from about 1 mm to about 100 mm.

Aspect 6. Methods of any one of aspects 3-5, wherein the vacuum is formed for a duration within a range from about 1 second to about 30 seconds at a pressure within a range from about 3 kPa to about 85 kPa.

Aspect 7. Methods of any one of aspects 1-6, wherein, after forming the vacuum, the second major surface comprises a flatness that is less than about 100 μm.

Aspect 8. Methods of any one of aspects 1-7, wherein, after forming the vacuum, the ribbon comprises an average stress that is less than about 7 MPa.

Aspect 9. Methods of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
applying a pressure to the ribbon to bias the ribbon toward the support surface.

Aspect 10. Methods of aspect 9, wherein the ribbon comprises a viscosity within a range from about 10⁶ poise to about 10¹⁰ poise.

Aspect 11. Methods of any one of aspects 9-10, wherein the pressure is applied by moving a pressing surface into contact with the first major surface.

Aspect 12. Methods of any one of aspects 9-11, wherein the pressure is applied within a range from about 0.1 MPa to about 5 MPa for a duration within a range from about 0.1 seconds to about 300 seconds.

Aspect 13. Methods of any one of aspects 9-12, wherein, after applying the pressure, the second major surface comprises a flatness that is less than about 100 μm.

Aspect 14. Methods of any one of aspects 9-13, wherein, after applying the pressure, the ribbon comprises an average stress that is less than about 7 MPa.

Aspect 15. Methods of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
planarizing a second major surface of the ribbon by maintaining the ribbon in contact with the support surface for a duration of time.

Aspect 16. Methods of aspect 15, wherein the ribbon comprises a viscosity within a range from about 10⁵ poise to about 10⁹ poise.

Aspect 17. Methods of any one of aspects 15-16, wherein the duration of time is within a range from about 4 minutes to about 60 minutes.

Aspect 18. Methods of any one of aspects 15-17, wherein, after planarizing the second major surface, the second major surface comprises a flatness that is less than about 100 μm.

Aspect 19. Methods of any one of aspects 15-18, wherein, after planarizing the second major surface, the ribbon comprises an average stress that is less than about 7 MPa.

Aspect 20. Methods of any one of aspects 15-19, wherein a first surface portion of the second major surface opposite the protrusion extends along a first plane, a second surface portion of the second major surface outside of the protrusion extends along a second plane, and a distance separating the first plane from the second plane is less than about 150 μm.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a perspective view of example aspects of a ribbon supported by a support surface in accordance with aspects of the disclosure;

FIG. 3 illustrates a top-down view of example aspects of a support surface comprising a plurality of openings in accordance with aspects of the disclosure;

FIG. 4 illustrates a top-down view of example aspects of a support surface comprising a plurality of openings in accordance with aspects of the disclosure;

FIG. 5 illustrates a side view of the support surface of FIG. 3 or FIG. 4 supporting the ribbon in accordance with aspects of the disclosure;

FIG. 6 illustrates a side view of example aspects of a support surface and a mold in accordance with aspects of the disclosure;

FIG. 7 illustrates a side view of example aspects of the support surface and the mold of FIG. 6 in accordance with aspects of the disclosure; and

FIG. 8 illustrates a cross-sectional view of example aspects of the support surface and the mold as viewed along lines 8-8 of FIG. 7 in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B (e.g., two different ends).

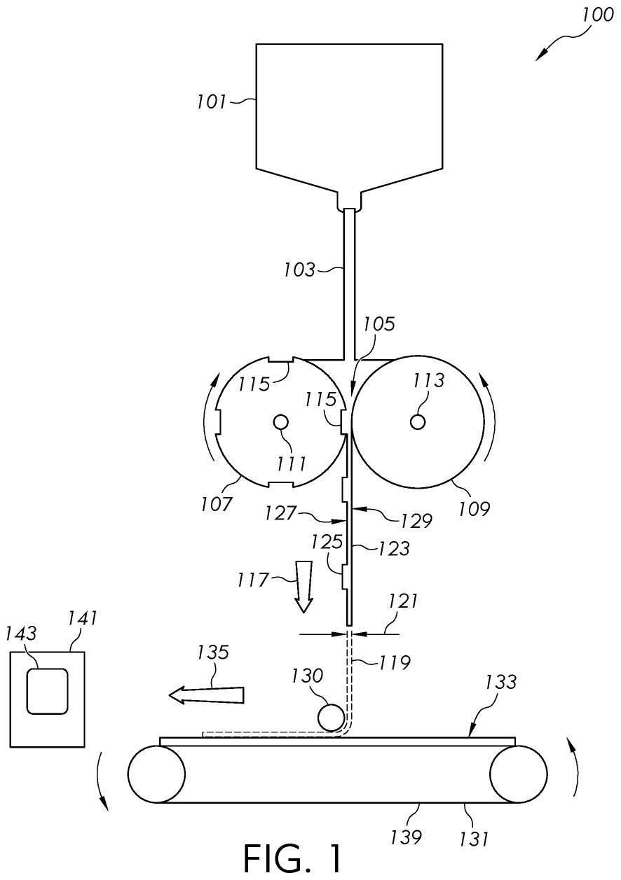

The present disclosure relates to a glass manufacturing apparatus and methods for forming a ribbon. For purposes of this application, “ribbon” may be considered one or more of a ribbon in a viscous state, a ribbon in an elastic state (e.g., at room temperature) and/or a ribbon in a viscoelastic state between the viscous state and the elastic state. The ribbon may comprise a ribbon of an indeterminate length or one or more separated glass articles (e.g., separated ribbons, separated sheets, etc.) that comprise four discrete edges. Methods and apparatus for manufacturing a ribbon will now be described by way of example aspects. As schematically illustrated in FIG. 1, in aspects, an exemplary glass manufacturing apparatus 100 can comprise a delivery apparatus 101 with a delivery conduit through which a stream of molten glass 103 can exit the delivery apparatus 101. For example, the delivery apparatus 101 can comprise an elongated passageway with an opening at the end of the delivery apparatus 101. In aspects, the delivery apparatus 101 can be oriented along a direction of gravity, such that the stream of molten glass 103 can flow downwardly along the direction of gravity from the delivery apparatus 101.

In aspects, the delivery apparatus 101 can define an upstream portion of a ribbon travel path 119 extending in a first travel direction 117. The delivery apparatus 101 can convey the stream of molten glass 103 along the ribbon travel path 119 in the first travel direction 117. In aspects, the glass manufacturing apparatus 100 can comprise one or more pairs of opposing forming rolls, for example, a first forming roll 107 and a second forming roll 109. The second forming roll 109 may be spaced from the first forming roll 107 to define a gap 105. The gap 105 provides a ribbon 123 with a width and a thickness 121. In aspects, the first forming roll 107 and the second forming roll 109 can rotate counter to one another. For example, in the orientation shown in FIG. 1, the first forming roll 107 can rotate in a clockwise direction while the second forming roll 109 can rotate in a counter-clockwise direction. In aspects, the first forming roll 107 and the second forming roll 109 can receive the stream of molten glass 103 along the travel path 119 within the gap 105. The stream of molten glass 103 can accumulate between the first forming roll 107 and the second forming roll 109, whereupon the first forming roll 107 and the second forming roll 109 can flatten, thin, and smooth the stream of molten glass 103 into the ribbon 123.

In aspects, the first forming roll 107 can extend along an axis 111 that is parallel to the travel path 119 and perpendicular to the first travel direction 117. The second forming roll 109 can extend along an axis 113 that is parallel to the travel path 119 and perpendicular to the first travel direction 117. In aspects, one or more of the first forming roll 107 or the second forming roll 109 can comprise a textured feature that may impart a corresponding textured feature to the ribbon 123. For example, in aspects, the textured feature of the forming roll(s) 107, 109 can comprise, for example, projections (e.g., extensions, outcroppings, etc.), recesses (e.g., openings, channels, etc.). As illustrated and described relative to FIG. 1, the textured feature of the first forming roll 107 can comprise a recess 115 that can impart a protrusion 125 to the ribbon 123 traveling along the ribbon travel path 119 in the first travel direction 117. The recess 115 can be formed at an outer surface of the first forming roll 107. For example, the first forming roll 107 can comprise a substantially circular cross-sectional shape. Accordingly, a radial distance from a center of the first forming roll 107 to the recess 115 may be less than a radial distance from a center of the first forming roll 107 to the outer surface of the first forming roll 107 at a location of the first forming roll 107 at which the recess 115 is not present. In aspects, additional recesses 115 can be spaced apart about a circumference of the first forming roll 107. In aspects, the recess 115 may cover the full circumference of the first forming roll 107, for example, to form strips instead of patches of thicker glass. In addition, or in the alternative, additional recesses can be located at differing locations about the axis 111 (e.g., which goes through the center of the first forming roll 107) of the first forming roll 107.

In aspects, the recess 115 can impart a corresponding textured feature, for example, the protrusion 125, to the ribbon 123. For example, as the stream of molten glass 103 travels through the gap 105, the stream of molten glass 103 can contact the first forming roll 107 and the second forming roll 109 such that the ribbon 123 can be formed and may exit the gap 105. In aspects, the contact between the first forming roll 107 and the ribbon 123 can impart the protrusion 125 to the ribbon 123. The ribbon 123 can contact the first forming roll 107 and may engage the recess 115, for example, by flowing into the recess 115. As a result, the recess 115 can cause the corresponding protrusion 125 in a first major surface 127 of the ribbon 123. The protrusion 125 may comprise a thicker area of the ribbon 123 as compared to locations immediately upstream and downstream from the protrusion 125. Accordingly, in aspects, methods of manufacturing the ribbon 123 can comprise contacting the ribbon 123 with the recess 115 of the first forming roll 107 to impart the protrusion 125 to the first major surface 127 of the ribbon 123.

A turning roll 130 may be located downstream from the forming rolls 107, 109 relative to the first travel direction 117 to change the travel direction of the travel path 119. For example, the turning roll 130 can direct the ribbon 123 to turn about 90 degrees such that the ribbon 123 can move from a substantially vertical orientation upstream from the turning roll 130 to a horizontal orientation downstream from the turning roll 130. In aspects, a conveyor 131 can support a surface 133 upon which the ribbon 123 is received. The conveyor 131 can move the surface 133 in a second travel direction 135 that is angled relative to the first travel direction 117. The surface 133 may be positioned downstream from the forming rolls 107, 109 and downstream from the turning roll 130 relative to the first travel direction 117 and the second travel direction 135 of the ribbon 123. In aspects, the conveyor 131 can comprise a belt conveyor apparatus (e.g., a belt conveyor) in which the conveyor 131 comprises two or more pulleys with a conveyor belt 139 or other endless loop carrying apparatus rotating about the pulleys. In aspects, one or more of the pulleys may be powered, thus moving the conveyor belt 139 and the surface 133. The ribbon 123 is not limited to being conveyed by the conveyor belt 139, and, alternatively, can be conveyed over an array of rollers.

The glass manufacturing apparatus 100 can comprise a furnace 141 that is located downstream from the delivery apparatus 101. The furnace 141 can comprise an interior 143 that is substantially hollow and within which the ribbon 123 can be received. In aspects, the ribbon 123 can be separated into discrete portions (e.g., sheets or segments) that may be received within the interior 143. The interior 143 of the furnace 141 may be maintained at an elevated temperature and can facilitate annealing of the ribbon 123. For example, a temperature of the furnace 141 can be controlled, such that controlled heating and/or cooling of the ribbon 123 can be achieved. This controlled heating and/or cooling can facilitate the formation of a desired stress within the ribbon 123. In aspects, the furnace 141 can comprise a batch furnace that may be heated or cooled as desired, or a lehr with temperatures of each zone fixed at different levels to heat and/or cool the ribbon per a desired thermal profile. As used herein, in aspects, the term “downstream” can refer to a separate, secondary process occurring after the ribbon 123 has been cut into separate sheets or separate ribbons, wherein the secondary process can begin after the sheets/ribbons have cooled down to room temperature. Alternatively, the term “downstream” can also refer to a time/location immediately after sheet/ribbon separation to partly bypass the cooling down and heating up (e.g., in-line with the rolling process).

In aspects, the ribbon 123 may comprise glass (e.g., a glass substrate or a glass ribbon), for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the ribbon 123 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. The ribbon 123 can alternatively comprise a ceramic, polymer, metal, multi-layer stack, or a composite of materials. The ribbon 123 can comprise several shapes, for example, square shapes, rectangular shapes, hexagonal shapes, irregular shapes, etc. In aspects, the ribbon 123 can be employed in a variety of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

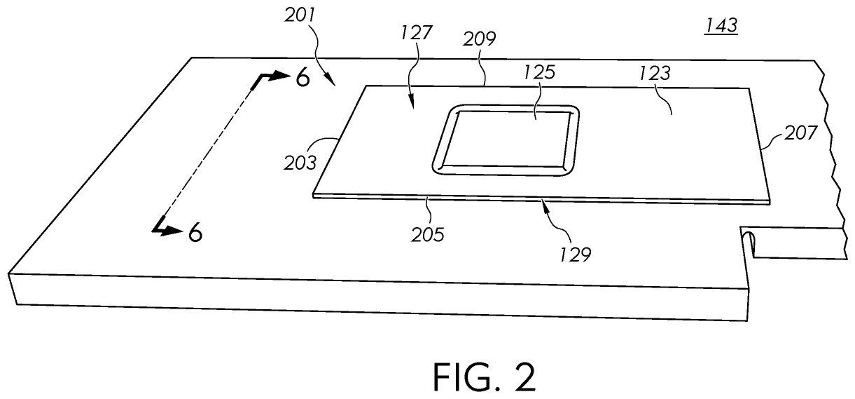

Referring to FIG. 2, the interior 143 of the furnace 141 is illustrated with the ribbon 123 positioned within the interior 143. In aspects, methods can comprise receiving the ribbon 123 on a support surface 201 positioned downstream from the forming rolls 107, 109 (e.g., within the furnace 141). In aspects, the ribbon 123 can be positioned in a controlled cooling furnace to take the ribbon 123 to a desired temperature for scoring or cutting the ribbon 123 into discrete ribbons (e.g., separated sheets). The discrete ribbon 123 can then be taken through a secondary furnace (e.g., either immediately or after cooling to room temperature), similar or identical to the furnace 141. In other aspects, the furnace 141 may be placed in-line shortly after the formation of the ribbon 123. Accordingly, the present application covers both situations. The second major surface 129 of the ribbon 123 opposite the first major surface 127 faces the support surface 201. In this way, the protrusion 125 can extend in a direction away from the support surface 201. By being positioned downstream from the forming rolls 107, 109, the ribbon 123 may be contacted by the forming rolls 107, 109 to impart the protrusion 125 prior to the ribbon 123 being received within the furnace 141. The ribbon 123 can be moved to the furnace 141 in several ways, for example, by the conveyor 131, by an operator manually moving the ribbon 123 into the interior 143, by a robotic apparatus picking and placing the ribbon 123 into the furnace 141, etc.

In aspects, the ribbon 123 can comprise a rectangular shape with a first edge 203, a second edge 205, a third edge 207, and a fourth edge 209. The first edge 203 is opposite the third edge 207, and the second edge 205 is opposite the fourth edge 209. The first edge 203 and the third edge 207 can comprise a shorter length than the second edge 205 and the fourth edge 209. The support surface 201 can comprise a larger size or footprint than the ribbon 123, such that all of the edges 203, 205, 207, 209 of the ribbon 123 can be supported by the support surface 201. The protrusion 125 can comprise several shapes. For example, as illustrated in FIG. 2, the protrusion 125 can comprise a square shape with a length that is within a range from about 25 millimeters (“mm”) to about 75 mm and a width that is within a range from about 25 mm to about 75 mm. In aspects, the protrusion 125 can comprise other quadrilateral shapes (e.g., a rectangular shape), rounded shapes (e.g., circular shapes, oval shapes, etc.), elongated shapes that extend across the ribbon 123 from one edge to an opposing edge, a plurality of protrusions, etc.

The support surface 201 can comprise a material that withstands the temperature within the furnace 141 without deforming or damaging the ribbon 123. For example, the support surface 201 can comprise a refractory material (e.g., a ceramic material) or a graphite-containing material. In aspects, the interior 143 may be maintained at a temperature within a range from about 700° Celsius (“C”) to about 1000° C., or within a range from about 875° C. to about 975° C. When the support surface 201 is exposed to these temperatures, the support surface 201 is resistant to warp or deformation, such that the support surface 201 may retain a substantially planar shape at all temperatures within the ranges. In aspects, to further protect the ribbon 123, the support surface 201 may be coated with a material, for example, a boron nitride spray. The support surface 201 may be substantially solid and may be free of openings. In aspects, the support surface 201 can comprise a flatness than is less than about 100 micrometers (“μm”), or less than about 50 μm.

Methods can comprise planarizing the second major surface 129 of the ribbon 123 by maintaining the ribbon 123 in contact with the support surface 201 for a duration of time. For example, second major surface 129 may be in contact with the support surface 201 for a duration of time that may be within a range from about 3 minutes to about 70 minutes, or within a range from about 4 minutes to about 60 minutes. In aspects, the ribbon 123 may comprise a viscosity within a range from about 10⁵ poise to about 10⁹ poise as the ribbon 123 is positioned within the furnace 141. The ribbon 123 may remain within the furnace for the duration of time at the temperature (e.g., within a range from about 700° C. to about 1000° C., or within a range from about 875° C. to about 975° C.). Due to the viscosity of the ribbon 123 from the temperature of the interior 143 for the duration of time, a shape of the ribbon 123 may change, for example, by being planarized. For example, a gravitational force may be exerted upon the ribbon 123 and cause the ribbon 123 to change shape. The ribbon 123, for example, the second major surface 129, may form a matching shape as the support surface 201 as a result of the second major surface 129 being in contact with the support surface 201. Due to the substantially planar shape of the support surface 201, the second major surface 129 may be planarized to form a matching substantially planar shape. In aspects, after planarization of the second major surface 129, the second major surface 129 can comprise a flatness that is less than about 100 μm μm, or less than about 50 μm. To reduce the likelihood of damage to the ribbon 123, the interior 143 may be cooled prior to removing the ribbon 123 from the furnace 141. For example, the interior 143 may be cooled to a predetermined temperature that is below an annealing point of the ribbon 123, for example, by cooling to a temperature that is less than about 600° C., less than about 500° C., less than about 400° C., or less than about 100° C. Upon reaching the predetermined temperature, the ribbon 123 may be removed. In aspects, after planarization of the second major surface 129, the ribbon 123 can comprise an average stress that is less than about 7 megapascals (“MPa”), or an average stress that is less than about 3 MPa. The average stress can comprise a through-thickness average, which can be measured, for example, using a birefringence technique in transmission mode. In aspects, the ribbon 123 can comprise a stress of less than about 25 nm of retardation per mm of ribbon thickness. In aspects, regarding the mold pressing, the stresses may depend on the cooling rates after the vacuum formation and may be tailored to achieve the desired stress targets.

The planarization of the second major surface 129 may achieve several benefits. For example, as a result of the formation of the protrusion 125 by the forming rolls 107, 109, the second major surface 129 may not be planar prior to being received within the furnace 141, but, rather, may comprise a flatness that is greater than about 100 μm. Further, at a location on the second major surface 129 that is opposite to and matching the location of the protrusion 125, the second major surface 129 may comprise a trench, for example, a non-planar region or depression that matches the shape of the protrusion 125 and is at or near the transition region of the thick to thin portion of the ribbon 123. An opposite feature may also be present, for example, a back-protrusion, which is a slight positive protrusion that matches the shape of the protrusion 125 and is at or near the transition region of the thick to thin portion of the ribbon 123. For example, in aspects, prior to the ribbon 123 being positioned within the furnace 141, a thickness of the ribbon 123 at different locations within the protrusion 125 may range from about 2.6 mm to about 2.9 mm, and a thickness of the ribbon 123 at different locations outside of the protrusion may range from about 1.1 mm to about 1.3 mm. By positioning the ribbon 123 within the furnace 141, the second major surface 129 may be planarized and the trench opposite the protrusion 125 may be minimized. The flatness of the second major surface 129 can be measured in several ways, for example, with a height gauge or an optical 3D scanner. In aspects, the flatness, which may be less than about 100 μm, or less than about 50 μm, can represent the total indicator run-out (TIR) which is the difference between a maximum and minimum measurement. The flatness measurements disclosed herein were measured using an optical 3D scanner.

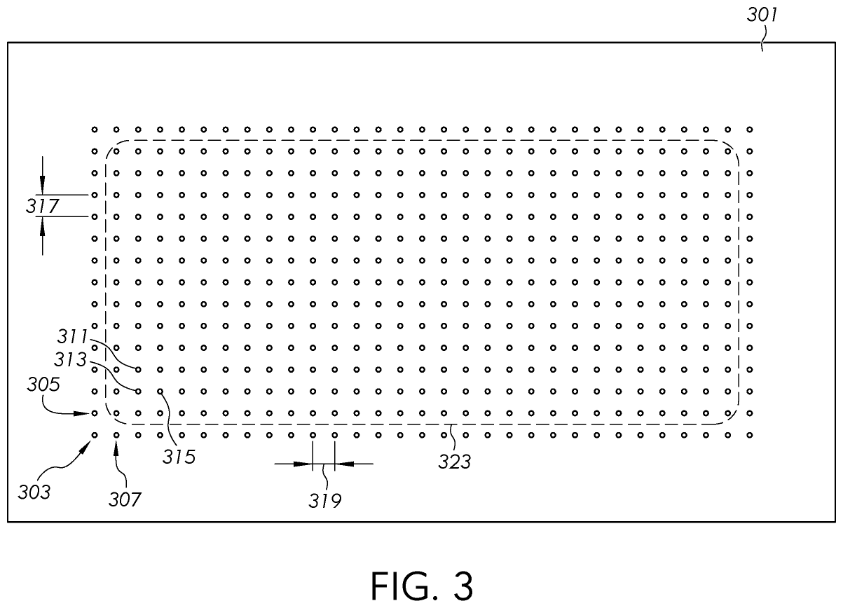

FIG. 3 illustrates a top-down view of aspects of a support surface 301 comprising a plurality of openings 303. As with the support surface 201 of FIG. 2, the support surface 301 can be positioned within the interior 143 of the furnace 141. Similar to FIG. 2, methods can comprise receiving the ribbon 123 on the support surface 301 positioned downstream from the forming rolls 107, 109, such that the second major surface 129 of the ribbon 123 opposite the first major surface 127 faces the support surface 301. In this way, the protrusion 125 can extend in a direction away from the support surface 301. In aspects, the support surface 301 can comprise a material that withstands the temperature within the furnace 141 without deforming or damaging the ribbon 123. The support surface 301 can comprise a refractory material (e.g., a ceramic material) or a graphite-containing material. In aspects, the interior 143 may be maintained at a temperature within a range from about 700° Celsius (“C”) to about 900° C., or within a range from about 750° C. to about 825° C. When the support surface 301 is exposed to these temperatures, the support surface 301 is resistant to warp or deformation, such that the support surface 301 may retain a substantially planar shape at all temperatures within the ranges. In aspects, the support surface 301 can comprise a flatness that is less than about 100 μm, or less than about 50 μm.

In aspects, a warp/diagonal² of the support surface 301 can be less than about 6×10⁻⁶/mm, wherein the warp can be measured as a function of the diagonal measurement of the ribbon 123 for which warp is to be determined. The diagonal is measured on a surface of the ribbon 123 having the greatest surface area. For example, if the ribbon 123 comprises an essentially rectangular shape (e.g., rectangular with rounded corners), the diagonal referred to in the warp measurement can be measured as a diagonal of the essentially rectangular surface. As another example, if the ribbon 123 has a circular surface, the diagonal is the diameter of the circle. As a further example, if the ribbon 123 has an oval-shaped surface, the diagonal is the longest straight line that can be drawn from one point on the circumference of the oval-shaped surface to another point on the oval-shaped surface. Thus, in embodiments, if the ribbon 123 is essentially rectangular and has a diagonal of 10 mm, the warp will be, in aspects, less than 0.15/10²=0.0015 mm.

The plurality of openings 303 may be spaced apart along the support surface 301. For example, the plurality of openings 303 can be arranged in a plurality of rows 305 and a plurality of columns 307. In aspects, the plurality of rows 305 may be spaced an equal distance apart from one another, for example, with a first distance separating a first row from a second row, and the first distance separating the second row from a third row. In aspects, each of the plurality of rows 305 may comprise an equal number of openings. In aspects, the plurality of columns 307 may be spaced an equal distance apart from one another, for example, with a second distance separating a first column from a second column, and the second distance separating the second column from a third column. In aspects, each of the plurality of columns 307 may comprise an equal number of openings.

In aspects, the plurality of openings 303 can comprise a first opening 311, a second opening 313, and a third opening 315. The first opening 311 and the second opening 313 may be positioned in one column, and the second opening 313 and the third opening 315 may be positioned in one row. In aspects, the second opening 313 can be spaced a distance 317 apart from the first opening 311, for example, with the distance 317 within a range from about 1 mm to about 100 mm, or within a range from about 1 mm to about 50 mm, or within a range from about 3 mm to about 7 mm. In aspects, the second opening 313 can be spaced a second distance 319 apart from the third opening 315, for example, with the second distance 319 within a range from about 1 mm to about 100 mm, or within a range from about 1 mm to about 50 mm, or within a range from about 3 mm to about 7 mm. In aspects, the plurality of openings 303 can comprise a substantially similar cross-sectional size and shape. For example, the plurality of openings 303 can comprise a quadrilateral shape (e.g., square, rectangular, etc.), a circular shape, etc. When the plurality of openings 303 comprise a circular shape, the plurality of openings 303 (e.g., the first opening 311, the second opening 313, the third opening 315, etc.) can comprise a diameter within a range from about 0.1 mm to about 3 mm. When the plurality of openings 303 comprise the quadrilateral shape, the plurality of openings 303 can comprise a maximum cross-sectional size within a range from about 0.1 mm to about 3 mm.

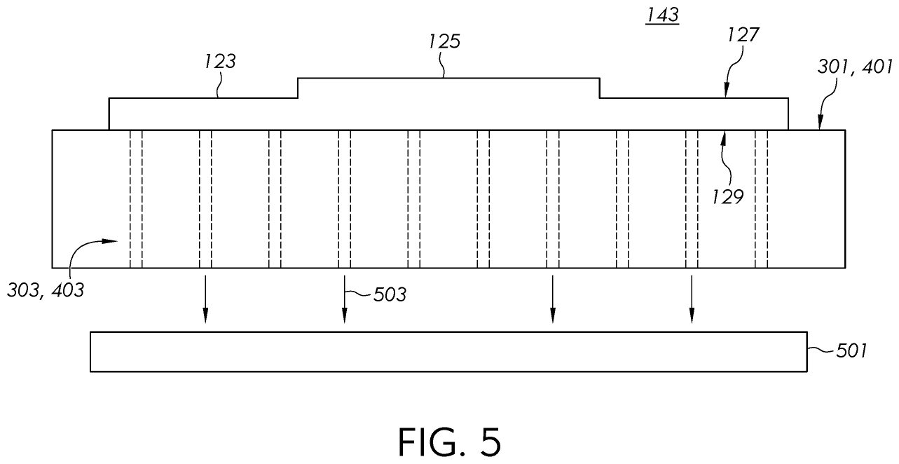

To facilitate planarization of the second major surface 129, the ribbon 123 can be positioned on the support surface 301 such that the ribbon 123 covers some or all of the plurality of openings 303. For example, as illustrated in FIG. 3, a position of the ribbon 123 is illustrated with dashed lines, wherein the position represents a footprint 323 of the ribbon 123 when the ribbon 123 is in contact with and supported by the support surface 301. In aspects, the ribbon 123 can cover a majority of the plurality of openings 303, such that substantially all areas of the ribbon 123 are covering openings 303 except for the portions of the ribbon 123 that lie between adjacent openings (e.g., between the first opening 311 and the second opening 313, between the second opening 313 and the third opening 315, etc.). In this way, substantially all areas of the ribbon 123 can be exposed to the openings 303. As described relative to FIG. 5, air can be drawn through the plurality of openings 303 to form a vacuum between the second major surface 129 and the support surface 301, thus planarizing the second major surface 129.

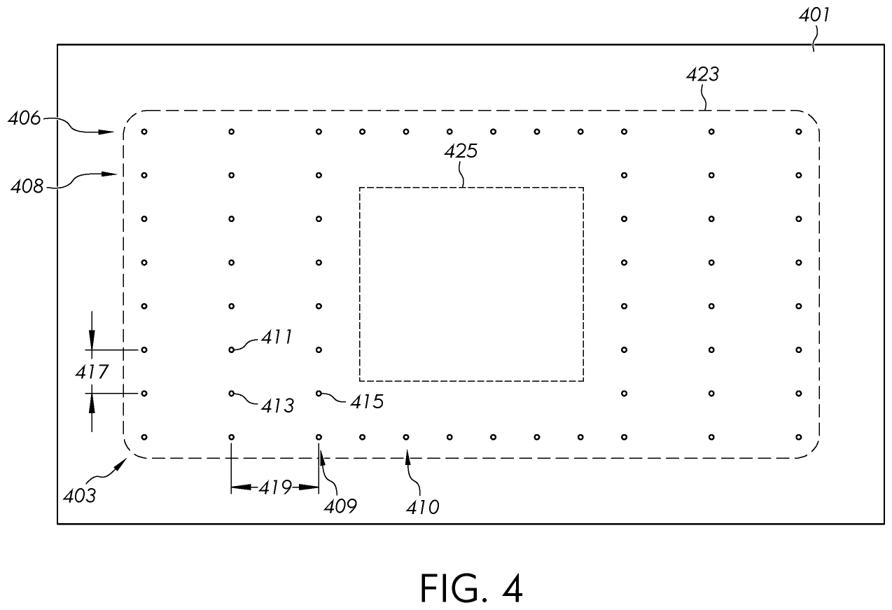

FIG. 4 illustrates a top-down view of aspects of a support surface 401 comprising a plurality of openings 403. In aspects, an arrangement of the plurality of openings 403 in FIG. 4 may differ from an arrangement of the plurality of openings 303 in FIG. 3 in that a distance separating the plurality of openings 403 may be greater than a distance separating the plurality of openings 303. In aspects, the support surface 401 can comprise the same material as the support surface 301 that can withstand the temperature within the furnace 141 without deforming or damaging the ribbon 123. The support surface 401 can be positioned within the interior 143, which may be maintained at a temperature within a range from about 700° C. to about 900° C., or within a range from about 750° C. to about 825° C. In aspects, the support surface 401 can comprise a flatness than is less than about 100 μm, or less than about 50 μm.

The plurality of openings 403 may be spaced apart along the support surface 401, for example, and may be arranged in a plurality of rows and a plurality of columns. In aspects, the plurality of rows may comprise a differing number of openings. For example, a first row 406 of the plurality of rows may comprise a first number of openings and a second row 408 of the plurality of rows may comprise a second number of openings, wherein the first number of openings is different than the second number of openings. Similarly, in aspects, the plurality of columns may comprise a differing number of openings. For example, a first column 409 of the plurality of columns may comprise a first number of openings and a second column 410 of the plurality of columns may comprise a second number of openings, wherein the first number of openings is different than the second number of openings. As such, a spacing between adjacent openings may differ. For example, the plurality of openings 403 can comprise a first opening 411, a second opening 413, and a third opening 415. The first opening 411 and the second opening 413 may be positioned in one column, and the second opening 413 and the third opening 415 may be positioned in one row. In aspects, the second opening 413 can be spaced a distance 417 apart from the first opening 411, for example, with the distance 417 within a range from about 1 mm to about 100 mm, or within a range from about 5 mm to about 50 mm, or within a range from about 15 mm to about 25 mm. In aspects, the second opening 413 can be spaced a second distance 419 apart from the third opening 415, for example, with the second distance 419 within a range from about 1 mm to about 100 mm, or within a range from about 5 mm to about 50 mm, or within a range from about 15 mm to about 25 mm. In aspects, the plurality of openings 403 can comprise a substantially similar cross-sectional size and shape. For example, the plurality of openings 403 can comprise a quadrilateral shape (e.g., square, rectangular, etc.), a circular shape, etc. When the plurality of openings 403 comprise a circular shape, the plurality of openings 403 can comprise a diameter within a range from about 0.1 mm to about 3 mm.

To facilitate planarization of the second major surface 129, the ribbon 123 can be positioned on the support surface 401 such that the ribbon 123 covers some or all of a portion of the plurality of openings 403. For example, as illustrated in FIG. 4, a position of the ribbon 123 is illustrated with dashed lines, wherein the position represents a footprint 423 of the ribbon 123 when the ribbon 123 is in contact with and supported by the support surface 401. A protrusion footprint 425 is illustrated with dashed lines and represents a location of the protrusion 125 relative to the ribbon 123 and the support surface 401. In aspects, the plurality of openings 403 can be arranged such that one or more openings are arranged outside of the protrusion footprint 425 and zero openings are arranged within the protrusion footprint 425. For example, the protrusion footprint 425 may not cover or be positioned over any of the openings, such that the protrusion footprint 425 is positioned over a solid and continuous area of the support surface 401. In aspects, the portion of the ribbon 123 that is outside of the protrusion footprint 425 and within the footprint 423 may cover some or all of the plurality of openings 403. Air can be drawn through the plurality of openings 403 to form a vacuum between the second major surface 129 and the support surface 401, thus planarizing the second major surface 129. A benefit of this configuration arises from a situation in which the protrusion 125 has sagged (e.g., a back-protrusion) due to the effect of gravity, and the second major surface 129 opposite the protrusion 125 (e.g., within the protrusion footprint 425) is offset from and lower than the second major surface 129 surrounding the protrusion 125 (e.g., outside of the protrusion footprint 425). As such, the openings outside of the protrusion footprint 425 can draw the portion of the second major surface 129 that is outside of the protrusion footprint 425 downwardly to planarize the second major surface 129.

Referring to FIG. 5, a side view of a support surface (e.g., the support surface 301 or the support surface 401) positioned within the interior 143 is illustrated with the second major surface 129 of the ribbon 123 in contact with the support surface 301, 401. In aspects, methods can comprise forming a vacuum between the second major surface 129 of the ribbon 123 and the support surface 301, 401 to bias the ribbon 123 toward the support surface 301, 401. For example, the plurality of openings 303, 403 (e.g., illustrated with dashed lines) can extend through the support surface 301, 401. The plurality of openings 303, 403 can be in fluid communication with a gas vacuum pump 501 that can remove gas from the plurality of openings 303, 403. The gas vacuum pump 501 and the plurality of openings 303, 403, can be in fluid communication in several ways, for example, via a conduit (e.g., pipe, tube, etc.), by being unitarily-formed with a rear side of the support surface 301, 401, etc. The gas vacuum pump 501 can be attached to the support surface 301, 401 such that the gas vacuum pump 501 can draw gas 503 in a flow direction away from the ribbon 123 and toward the gas vacuum pump 501. In this way, the gas vacuum pump 501 can form a vacuum between the second major surface 129 and the support surface 301, 401.

In aspects, the ribbon 123 can comprise a viscosity within a range from about 10⁶ poise to about 10¹⁰ poise as the ribbon 123 is in contact with the support surface 301, 401. Initially, the ribbon 123 may be placed on the support surface 301, 401 and the interior 143 may be heated to the desired temperature, for example, a range from about 700° C. to about 900°. After the desired temperature is reached, a period of time may elapse prior to forming the vacuum, for example, a time sufficient to achieve a viscosity suitable for shaping the ribbon 123, for example a viscosity within the above-stated range. For example, the period of time may be within a range from about zero minutes to about 60 minutes, or about 4 minutes to about 60 minutes. Next, the vacuum may be formed for a duration that is within a range from about 1 second to about 30 seconds at a pressure within a range from about 3 kilopascals (kPa) to about 85 kPa. The ribbon 123 may remain within the furnace 141 and may be exposed to the vacuum for the duration of time at the temperature (e.g., within a range from about 700° C. to about 900° C., or within a range from about 750° C. to about 825° C.). Following the formation of the vacuum, the interior 143 may be cooled prior to removal of the ribbon 123 from the support surface 301, 401.

Due to the viscosity of the ribbon 123 and the formation of the vacuum, a shape of the ribbon 123 may change, for example, by being planarized. For example, the vacuum may exert a force upon the ribbon 123 and cause the ribbon 123 to change shape due to a relatively low viscosity. After forming the vacuum, the ribbon 123, for example, the second major surface 129, may comprise a flatness that is less than about 100 μm, or less than about 50 μm. In aspects, after forming the vacuum, the ribbon 123 may comprise an average stress that is less than about 7 MPa, or less than about 3 MPa. In aspects, regarding the mold pressing, the stresses may depend on the cooling rates after the vacuum formation and may be tailored to achieve the desired stress targets. In aspects, to reduce oxidation of the support surface 301, 401, the interior 143 may be purged with a gas, for example, argon gas, prior to, during, and/or after the formation of the vacuum between the ribbon 123 and the support surface 301, 401. For example, the gas, for example, argon gas, can be pumped into the interior 143, thus causing oxygen to be evacuated from the interior 143. As a result of this gas purge, when the support surface 301, 401 comprises a graphite material, the support surface 301, 401 may be resistant to oxidation at elevated temperatures (e.g., within a range from about 700° C. to about 900° C.).

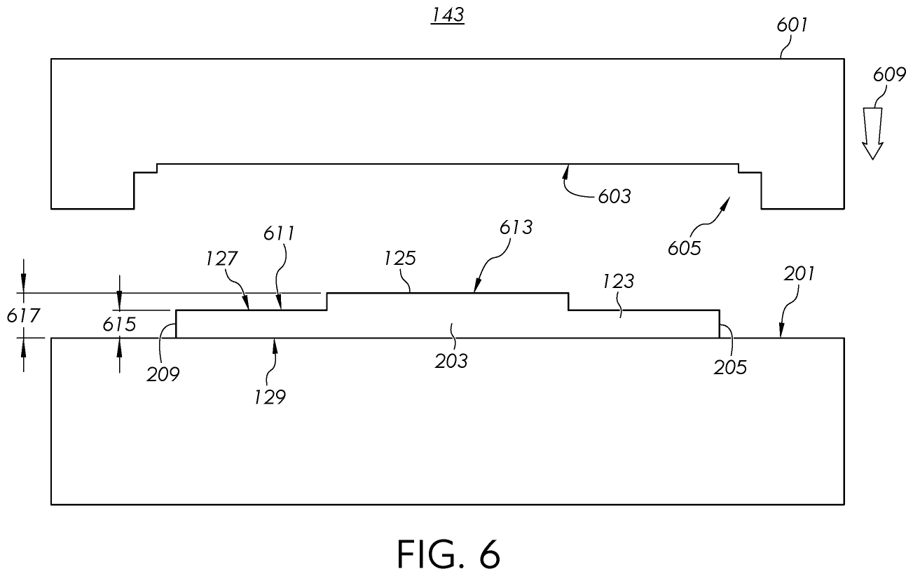

FIG. 6 illustrates a side view of aspects of the ribbon 123 supported by the support surface 201 as viewed along lines 6-6 of FIG. 2, wherein a mold 601 can apply a pressure to the ribbon 123 to planarize the ribbon 123. In aspects, the ribbon 123 can be positioned on the support surface 201 within the interior 143 of the furnace 141. Methods can comprise receiving the ribbon 123 on the support surface 201 positioned downstream from the forming roll 107, 109, with the second major surface 129 of the ribbon 123 opposite the first major surface 127 and facing the support surface 201, and the protrusion 125 extending in a direction away from the support surface 201. The mold 601 can comprise a pressing surface 603 that faces the ribbon 123. In aspects, the mold 601 can comprise a mold cavity 605 that is at least partially defined by the pressing surface 603. The mold cavity 605 can be sized larger than the ribbon 123 such that the ribbon 123 can be received within the mold cavity 605 when the pressing surface 603 contacts the ribbon 123. The mold 601 is not limited to comprising the mold cavity 605, and, in aspects, a bottom of the mold 601 (e.g., facing the ribbon 123) can be substantially planar. In aspects, the pressing surface 603 can be substantially planar and may be oriented to extend along a plane that is substantially parallel to a plane defined by the support surface 201.

The mold 601 may initially be spaced a distance apart from the support surface 201 such that the ribbon 123 can be positioned on the support surface 201 without the mold 601 interfering or contacting the ribbon 123. The ribbon 123 can be positioned on the support surface 201 similar to the aspects of FIG. 2, wherein the second major surface 129 may be in contact with the support surface 201 and the first major surface 127 facing away from the support surface 201. Once the ribbon 123 has been positioned on the support surface 201, the mold 601 can be moved in a movement direction 609 toward the ribbon 123 and the support surface 201. The first major surface 127 of the ribbon 123 can comprise a first surface portion 611 and a second surface portion 613. The second surface portion 613 can comprise the surface that defines the protrusion 125 while the first surface portion 611 surrounds the protrusion 125. As such, the ribbon 123 can comprise a first thickness 615, which is measured between the first surface portion 611 and the second major surface 129, and a second thickness 617, which is at the protrusion 125 and measured between the second surface portion 613 and the second major surface 129. The second thickness 617 is larger than the first thickness 615.

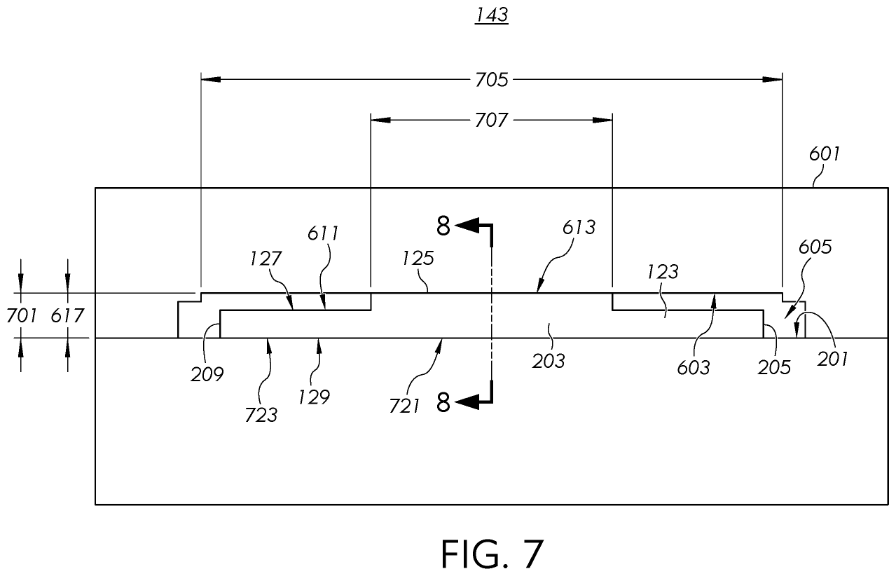

FIG. 7 illustrates a side view of the mold 601 contacting the ribbon 123 after the mold 601 has moved in the movement direction 609 of FIG. 6. In aspects, the mold 601 can be moved in the movement direction 609 at least until the pressing surface 603 reaches a first distance 701 from the support surface 201. Upon the pressing surface 603 reaching the first distance 701, the mold 601 may stop moving in the movement direction 609. In aspects, the first distance 701 can substantially match the second thickness 617 of the ribbon 123 at the protrusion 125. For example, the ribbon 123 can comprise the second thickness 617 measured between the second major surface 129 and the second surface portion 613. As a result of the forming process of the ribbon 123, in aspects, the second thickness 617 may vary. For example, at a first location at the protrusion 125, the ribbon 123 can comprise a thickness that differs from a thickness at a second location at the protrusion 125. In aspects, the second thickness 617 can vary within a range from about 1.8 mm to about 3.5 mm, or about 2.3 mm to about 3.1 mm, or about 2.6 mm to about 2.9 mm at differing locations. To reduce these thickness variations, the mold 601 can be moved such that the pressing surface 603 reaches the first distance 701, wherein the first distance 701 can substantially match a desired thickness (e.g., for the second thickness 617) of the ribbon 123.

As the mold 601 moves in the movement direction 609, the pressing surface 603 can contact the second surface portion 613 of the ribbon 123. The pressing surface 603 may not contact the first surface portion 611 and, instead, may remain spaced a distance apart from the first surface portion 611. For example, in aspects, the pressing surface 603 can comprise a first length 705 that may be measured in a direction parallel to the first edge 203. The second surface portion 613 can comprise a second length 707 measured in a direction parallel to the first length 705. In aspects, the first length 705 may be greater than the second length 707, such that the pressing surface 603 may contact less than all of the first major surface 127, for example, by contacting the second surface portion 613 and not the first surface portion 611. By contacting the second surface portion 613, the pressing surface 603 can reduce thickness variations at the protrusion 125. For example, at locations within the protrusion 125 that comprise a thickness greater than the first distance 701, the pressing surface 603 can apply a pressure and reduce the thickness. In aspects, the second major surface 129 can likewise be planarized. For example, as a result of the pressing surface 603 contacting the protrusion 125, the mold 601 can bias the second major surface 129 toward the support surface 201. The second major surface 129 can be planarized such that warp at the second major surface 129 can be reduced. For example, in aspects, a first surface portion 721 of the second major surface 129 opposite the protrusion 125 can extend along a first plane, and a second surface portion 723 of the second major surface 129 outside of the protrusion 125 can extend along a second plane. In aspects, following the planarization, a distance separating the first plane from the second plane may be less than about 150 μm, or may be less than about 50 μm.

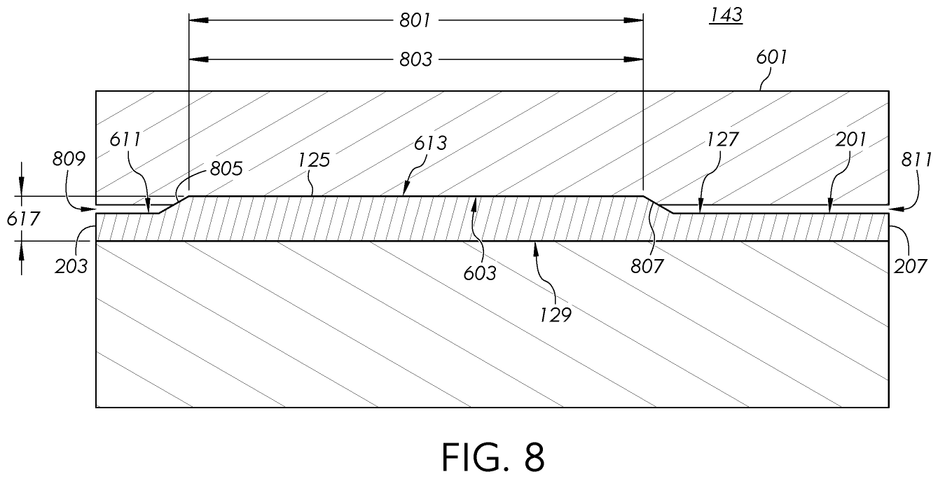

FIG. 8 illustrates a cross-sectional view of the ribbon 123, the support surface 201, and the mold 601 as viewed along lines 8-8 of FIG. 7. In aspects, the mold 601 can comprise an asymmetrical shape along different axes of the ribbon 123. For example, as illustrated in FIG. 6-7, in a direction facing the first edge 203 of the ribbon 123, the pressing surface 603 can be substantially planar and may comprise a length that is larger than a length of the second surface portion 613, such that the first length 705 of the pressing surface 603 is larger than the second length 707 of the second surface portion 613. As illustrated in FIG. 8, in a perpendicular direction (e.g., in a direction perpendicular to the first edge 203 and the third edge 207), the pressing surface 603 may comprise a first length 801 that is substantially equal to a second length 803 of the second surface portion 613. The mold 601 may comprise edges, for example, a first edge 805 and a second edge 807 that define the ends of the pressing surface 603. For example, the first edge 805 may be located at a first end of the pressing surface 603 and the second edge 807 may be located at an opposing second end of the pressing surface 603, with the first edge 805 and the second edge 807 angled relative to the pressing surface 603.

In aspects, as the mold 601 moves in the movement direction 609, the pressing surface 603 can contact the second surface portion 613 of the ribbon 123. The first edge 805 and the second edge 807 may contact the edges of the protrusion 125 such that substantially all of the second surface portion 613 is contacted by the pressing surface 603. In aspects, a gap may be present between the mold 601 and the first surface portion 611, for example, a first gap 809 on a first side of the protrusion 125 and a second gap 811 on a second side of the protrusion 125. The gaps 809, 811 can allow for material from the protrusion 125 to migrate to other portions of the ribbon 123 when pressure is applied to the protrusion 125. For example, when the protrusion 125 is contacted by the pressing surface 603 and the second thickness 617 of the protrusion 125 is reduced, a portion of the material from the protrusion 125 may migrate to other areas of the ribbon 123, for example. The gaps 809, 811 can allow for a thickness of the ribbon 123 between the first surface portion 611 and the second major surface 129 to increase as a result of a decrease in the second thickness 617 of the protrusion 125.

Prior to applying the pressure to the ribbon 123 from the mold 601, the support surface 201 and the mold 601 can be gradually heated to achieve a desired temperature and viscosity within the ribbon 123. For example, the support surface 201 and the mold 601 can be gradually heated from about 500° C. to about 900° C. in about 450 seconds. In aspects, to gradually heat the support surface 201 and the pressing surface 603, the support surface 201 and the pressing surface 603 can each initially be heated to a temperature within a range from about 500° C. to about 600° C., or from about 525° C. to about 575° C., or about 550° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be heated and maintained at a temperature within a range from about 600° C. to about 700° C., or from about 625° C. to about 675° C., or about 650° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be heated and maintained at a temperature within a range from about 725° C. to about 775° C., or about 750° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be heated and maintained at a temperature within a range from about 775° C. to about 785° C., or about 780° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be heated and maintained at a temperature within a range from about 800° C. to about 850° C., or about 820° C. and maintained at that temperature for a duration within a range from about 70 seconds to about 110 seconds, or within a range from about 80 seconds to about 100 seconds, or about 90 seconds.

After the duration of time has passed, the mold 601 can be moved in the movement direction 609 to apply the pressure to the ribbon 123. As such, methods can comprise applying a pressure to the ribbon 123 to bias the ribbon toward the support surface 201. For example, the pressure can be applied by moving the pressing surface 603 into contact with the first major surface 127. In aspects, the pressure can be applied within a range from about 0.1 MPa to about 5 MPa, or within a range from about 0.5 MPa to about 1.5 MPa, or about 0.9 MPa. In aspects, the pressure can be applied for a duration within a range from about 0.1 seconds to about 300 seconds, or within a range from about 100 seconds to about 150 seconds, or about 130 seconds. As the mold 601 contacts the ribbon 123, the ribbon 123 can comprise a viscosity within a range from about 10⁶ poise to about 10¹⁰ poise.

Following the application of pressure to the ribbon 123, the mold 601 and the support surface 201 can be gradually cooled to control an average stress of the ribbon 123. For example, as part of a first cooling scenario, the support surface 201 and the pressing surface 603 can be cooled and maintained at a temperature within a range from about 600° C. to about 700° C., or within a range from about 625° C. to about 675° C., or about 650° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be cooled and maintained at a temperature within a range from about 500° C. to about 600° C., or within a range from about 525° C. to about 575° C., or about 550° C. and maintained at that temperature for a duration within a range from about 70 seconds to about 110 seconds, or within a range from about 80 seconds to about 100 seconds, or about 90 seconds. After the duration of time has passed, the support surface 201 and the pressing surface 603 can be cooled and maintained at a temperature within a range from about 200° C. to about 400° C., or within a range from about 250° C. to about 350° C., or about 300° C. and maintained at that temperature for a duration within a range from about 70 seconds to about 110 seconds, or within a range from about 80 seconds to about 100 seconds, or about 90 seconds. The ribbon 123 may then be removed from the mold 601 and the support surface 201. As a result of the first cooling scenario, the ribbon 123 can comprise an average maximum stress along an axis parallel to the second edge 205 that bisects the protrusion 125 that is about 8.5 MPa.

In aspects, a second cooling scenario can be carried out that more quickly cools the ribbon 123 than the first cooling scenario. For example, as part of the second cooling scenario, the support surface 201 can be cooled and maintained at a temperature within a range from about 400° C. to about 500° C., or about 450° C. and the pressing surface 603 can be cooled and maintained at a temperature within a range from about 300° C. to about 400° C., or about 375° C., wherein these temperatures can be maintained for a duration within a range from about 40 seconds to about 50 seconds, or about 45 seconds. After the duration of time has passed, the support surface 201 and the pressing surface 603 can be cooled and maintained at a temperature within a range from about 150° C. to about 250° C., or about 200° C. for a duration within a range from about 40 seconds to about 50 seconds, or about 45 seconds. After the duration of time has passed, the support surface 201 and the pressing surface 603 can be cooled and maintained at a temperature within a range from about 100° C. to about 150° C., or about 125° C. for a duration within a range from about 40 seconds to about 50 seconds, or about 45 seconds. The ribbon 123 may then be removed from the mold 601 and the support surface 201. As a result of the second cooling scenario, the ribbon 123 can comprise an average maximum stress along an axis parallel to the second edge 205 that bisects the protrusion 125 that is about 24 MPa.

In aspects, a third cooling scenario can be carried out that more quickly cools the ribbon 123 than the first cooling scenario or the second cooling scenario. For example, as part of the third cooling scenario, the support surface 201 can be cooled and maintained at a temperature within a range from about 250° C. to about 350° C., or about 280° C. and the pressing surface 603 can be cooled and maintained at a temperature within a range from about 200° C. to about 250° C., or about 220° C., wherein these temperatures can be maintained for a duration within a range from about 40 seconds to about 50 seconds, or about 45 seconds. After the duration of time has passed, the support surface 201 and the pressing surface 603 can be cooled and maintained at a temperature within a range from about 100° C. to about 200° C., or about 150° C. for a duration within a range from about 40 seconds to about 50 seconds, or about 45 seconds. After the duration of time has passed, the support surface 201 and the pressing surface 603 can be cooled and maintained at a temperature within a range from about 50° C. to about 150° C., or about 90° C. for a duration within a range from about 40 seconds to about 50 seconds, or about 45 seconds. The ribbon 123 may then be removed from the mold 601 and the support surface 201. As a result of the third cooling scenario, the ribbon 123 can comprise an average maximum stress along an axis parallel to the second edge 205 that bisects the protrusion 125 that is about 32 MPa.

In aspects, under any of the aforementioned cooling scenarios, after applying the pressure to the ribbon 123, the second major surface 129 can comprise a flatness that is less than about 100 μm, or less than about 50 μm. In aspects, under any of the aforementioned cooling scenarios, after applying the pressure to the ribbon 123, the ribbon 123 can comprise an average stress that is less than about 7 MPa, or less than about 3 MPa.

The aforementioned methods of planarizing the ribbon 123 can yield several benefits that reduce manufacturing time and expense. For example, the second major surface 129 can be planarized and a trench defect or a back-protrusion can be mitigated. The trench defect can occur when the portion of the second major surface 129 within the protrusion footprint 425 (e.g., illustrated in FIG. 4) is offset and recessed from the portion of the second major surface 129 outside of the protrusion footprint 425. The trench defect can occur when the portion of the second major surface 129 within the protrusion footprint 425 (e.g., illustrated in FIG. 4) is offset and protruding from the portion of the second major surface 129 outside of the protrusion footprint 425. In aspects, the methods of planarization and trench defect mitigation can be achieved with minimal grinding or polishing, which can be inefficient. Further, existing methods of forming the ribbon 123 (e.g., via the delivery apparatus 101, the forming rolls 107, 109, the furnace 141, etc. illustrated in FIG. 1) can be carried out without modification to existing lines (e.g., as the methods can be applied as a secondary process), since the methods of planarizing the ribbon 123 can occur downstream from the forming rolls 107, 109. In addition, by controlling the temperature of the furnace 141, the support surfaces 201, 301, 401, and the mold 601, the stress within the ribbon 123 can be controlled. For example, the furnace 141, the support surfaces 201, 301, 401, and the mold 601 can be gradually heated or cooled and maintained at desired temperatures for predetermined periods of time, thus facilitating an average stress of the ribbon 123 that is less than about 7 MPa, or less than about 3 MPa. In addition, the methods can accommodate several different shapes and dimensions of the ribbon 123. For example, a thickness and/or shape of the ribbon 123 can be varied, and a thickness and/or shape of the protrusion 125 can be varied while still planarizing the second major surface 129 via any of the methods.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A method of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
forming a vacuum between the second major surface of the ribbon and the support surface to bias the ribbon toward the support surface.

2. The method of claim 1, wherein the ribbon comprises a viscosity within a range from about 10⁶ poise to about 10¹⁰ poise.

3. The method of claim 1, wherein the support surface comprises a plurality of openings.

4. The method of claim 3, wherein a first opening of the plurality of openings comprises a diameter within a range from about 0.1 mm to about 3 mm.

5. The method of claim 4, wherein a second opening of the plurality of openings is spaced a distance apart from the first opening, the distance within a range from about 1 mm to about 100 mm.

6. The method of claim 3, wherein the vacuum is formed for a duration within a range from about 1 second to about 30 seconds at a pressure within a range from about 3 kPa to about 85 kPa.

7. The method of claim 1, wherein, after forming the vacuum, the second major surface comprises a flatness that is less than about 100 μm.

8. The method of claim 1, wherein, after forming the vacuum, the ribbon comprises an average stress that is less than about 7 MPa.

9. A method of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
applying a pressure to the ribbon to bias the ribbon toward the support surface.

10. The method of claim 9, wherein the ribbon comprises a viscosity within a range from about 10⁶ poise to about 10¹⁰ poise.

11. The method of claim 9, wherein the pressure is applied by moving a pressing surface into contact with the first major surface.

12. The method of claim 9, wherein the pressure is applied within a range from about 0.1 MPa to about 5 MPa for a duration within a range from about 0.1 seconds to about 300 seconds.

13. The method of claim 9, wherein, after applying the pressure, the second major surface comprises a flatness that is less than about 100 μm.

14. The method of claim 9, wherein, after applying the pressure, the ribbon comprises an average stress that is less than about 7 MPa.

15. A method of manufacturing a ribbon comprising:
contacting the ribbon with a recess of a forming roll to impart a protrusion to a first major surface of the ribbon;
receiving the ribbon on a support surface positioned downstream from the forming roll, a second major surface of the ribbon opposite the first major surface facing the support surface, and the protrusion extending in a direction away from the support surface; and
planarizing the second major surface of the ribbon by maintaining the ribbon in contact with the support surface for a duration of time.

16. The method of claim 15, wherein the ribbon comprises a viscosity within a range from about 10⁵ poise to about 10⁹ poise.

17. The method of claim 15, wherein the duration of time is within a range from about 4 minutes to about 60 minutes.

18. The method of claim 15, wherein, after planarizing the second major surface, the second major surface comprises a flatness that is less than about 100 μm.

19. The method of claim 15, wherein, after planarizing the second major surface, the ribbon comprises an average stress that is less than about 7 MPa.

20. The method of claim 15, wherein a first surface portion of the second major surface opposite the protrusion extends along a first plane, a second surface portion of the second major surface outside of the protrusion extends along a second plane, and a distance separating the first plane from the second plane is less than about 150 μm.
